(19) United States
(12) Patent Application Publication
(10) Pub. No.: US 2025/0192824 A1
(43) Pub. Date: Jun. 12, 2025

(54) INTERFERENCE MITIGATION USING PHASE MODIFICATION OF AN INTERFERENCE SIGNAL FOR A USER EQUIPMENT (UE)

(71) Applicant: QUALCOMM Incorporated, San Diego, CA (US)

(72) Inventors: Prasidh Ramabadran, Bangalore (IN); Madhav Venkateswaran, Hyderabad (IN); Tejinder Dip Singh, Bangalore (IN); A R Prasad Paramkusam, Hyderabad (IN); Chhavi Kush, Bangalore (IN); Saranyan Nagarajan, Hyderabad (IN)

(21) Appl. No.: 18/532,464

(22) Filed: Dec. 7, 2023

(51) Int. Cl. H04B 7/01; H04B 7/06; H04B 7/08; H04B 17/336

(52) U.S. Cl. CPC H04B 7/01; H04B 7/0634; H04B 7/086; H04B 17/336

(57) ABSTRACT

In some aspects of the disclosure, an apparatus for wireless communication by a user equipment (UE) includes a primary receive (PRx) path associated with a first antenna and configured to receive a wireless signal. The apparatus further includes a diversity receive (DRx) path associated with a second antenna antenna. The apparatus further includes a phase shifter configured to phase-modify an interference signal from the second antenna based at least in part on a physical distance between the first antenna and the second antenna and further based on an angle of arrival (AoA) associated with the interference signal. The apparatus further includes a circuit configured to generate a received signal based on the wireless signal and the phase-modified interference signal.

### TECHNICAL FIELD

Aspects of the present disclosure relate generally to wireless communication systems, and more particularly, to phase modification of an interference signal for a user equipment (UE) within a wireless communication system.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

### BRIEF SUMMARY OF SOME EXAMPLES

In some aspects of the disclosure, an apparatus for wireless communication by a user equipment (UE) includes a primary receive (PRx) path associated with a first antenna and configured to receive a wireless signal. The apparatus further includes a diversity receive (DRx) path associated with a second antenna. The apparatus further includes a phase shifter configured to phase-modify an interference signal from the second antenna based at least in part on a physical distance between the first antenna and the second antenna and further based on an angle of arrival (AoA) associated with the interference signal. The apparatus further includes a circuit configured to generate a received signal based on the wireless signal and the phase-modified interference signal.

In some other aspects, a method of wireless communication by a user equipment (UE) includes receiving a wireless signal using a PRx path associated with a first antenna and receiving an interference signal using DRx path associated with a second antenna. The method further includes phase-modifying the interference signal based at least in part on a physical distance between the first antenna and the second antenna and further based on an AoA associated with the interference signal. The method also includes generating a received signal based on the wireless signal and the phase-modified interference signal.

In some additional aspects, a non-transitory computer-readable medium stores instructions executable by one or more processors to initiate, control, or perform operations. The operations include receiving a wireless signal using a PRx path associated with a first antenna and receiving an interference signal using a DRx path associated with a second antenna. The operations further include phase-modifying the interference signal based at least in part on a physical distance between the first antenna and the second antenna and further based on an AoA associated with the interference signal. The operations further include generating a received signal based on the wireless signal and the phase-modified interference signal.

In some further aspects, an apparatus includes a processing system that includes processor circuitry and memory circuitry that stores code. The processing system is configured to receive a wireless signal using a PRx path associated with a first antenna and to receive an interference signal using a DRx path associated with a second antenna. The processing system is further configured to phase-modify the interference signal based at least in part on a physical distance between the first antenna and the second antenna and further based on an AoA associated with the interference signal. The processing system is further configured to generate a received signal based on the wireless signal and the phase-modified interference signal.

In some additional aspects, an apparatus for wireless communication by a UE includes means for receiving a wireless signal associated with a first antenna and further includes means for receiving an interference signal associated with a second antenna. The apparatus further includes means for phase-modifying the interference signal based at least in part on a physical distance between the first antenna and the second antenna and further based on an AoA associated with the interference signal. The apparatus further includes means for generating a received signal based on the wireless signal and the phase-modified interference signal.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating a frequency (RF) transceiver according to one or more aspects.

FIG. 4 is a block diagram illustrating an example of a system according to one or more aspects.

FIG. 5 is a block diagram illustrating another example of a system according to one or more aspects.

FIG. 6A is a block diagram illustrating examples of features that may be associated with a baseband processor according to one or more aspects.

FIG. 6B is a block diagram illustrating another example of a system according to one or more aspects.

FIG. 7 is a flow chart illustrating an example of a method according to one or more aspects.

FIG. 8 is a flow chart illustrating another example of a method according to one or more aspects.

FIG. 9 is a block diagram of an example of a user equipment (UE) according to one or more aspects.

### DETAILED DESCRIPTION

Interference may reduce performance in a wireless communication system, such as by causing a user equipment (UE) or other device to experience receiver saturation and other effects. For example, if the UE is near the periphery of a cell of a base station, then communications received from the base station may be relatively weak, and the UE may increase the gain of a receiver of the UE. If a source of interference is relatively close to the UE, the increased gain may cause the receiver to amplify the interference, which may saturate or desensitize the receiver, resulting in poor communication with the base station.

To compensate for such interference, some UEs and other devices may use filters and other techniques that attempt to reduce or remove interference from received signals. Such filters and other techniques may be relatively expensive. For example, some such filters may be large or costly and may decrease signal power of a received signal, increase power consumption, or both. Further, such filtering techniques may not adequately reduce or remove interference in at least some circumstances. In addition, quality of a received signal may be affected or degraded by such filtering techniques in some cases. For example, a received signal may be affected or degraded by a non-linear group delay or a phase-variation of a transfer function of a filter, which may increase with the order of the filter. Some devices may use sharp filtering around a fundamental band of operation to attempt to attenuate such effects. In some circumstances, such sharp filtering may be insufficient to attenuate some interfering signals, such as interfering signals at odd harmonic bands.

In some aspects of the disclosure, a UE may use a primary receive (PRx) antenna to receive a wireless signal (such as a desired signal) and may use a diversity receive (DRx) antenna to receive an interferer (also referred to herein as a jammer). The UE may determine an angle of arrival (AoA) of the interferer and may determine an amount of phase rotation to apply to the interferer based on the AoA and further based on a distance between the PRx antenna and the DRx antenna. The UE may phase-rotate the interferer to generate a phase-rotated version of the interferer, which may be referred to as creating a null in the AoA of the interferer. The phase-rotated version of the interferer may be combined with the wireless communication signal of interest to reduce, mitigate, or cancel an effect of the interferer on the wireless signal.

The UE may include a phase shifter that performs the phase rotation of the interferer. In some implementations, the phase shifter may be included in a baseband processor of the UE. For example, the phase shifter may be implemented using instructions executed by the baseband processor. Implementing the phase shifter via processor-executable instructions in such a manner may reduce or simplify receiver hardware of the UE.

In some other implementations, the UE may include another type of phase shifter. For example, the phase shifter may be coupled between the DRx antenna and a low noise amplifier (LNA) of the UE. In such implementations, the interferer may be attenuated in the wireless signal relatively early in a receive chain of the UE, which may be beneficial in some cases. For example, the interferer may be attenuated in the wireless signal prior to amplifying the wireless signal via the LNA, which may reduce or avoid excessive amplification and receiver saturation in some cases. Alternatively, or in addition, by inputting a lower amplitude signal (after reduction of the interferer) to the LNA, an amount of amplification by the LNA may be increased, which may ensure that the desired wireless signal is amplified to an appropriate level.

One or more features described herein may improve performance of a UE or other device that includes a receiver. For example, interference reduction via phase rotation of an interferer may be facilitated using relatively low-cost instructions, hardware, or both, and may be implemented instead of costly filters or other techniques. Further, by reducing the interferer in the wireless signal, a higher gain may be applied to the wireless signal without causing receiver saturation, which may be beneficial in some cases in which the wireless signal has a relatively small amplitude (e.g., where the UE is near the periphery of a cell).

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

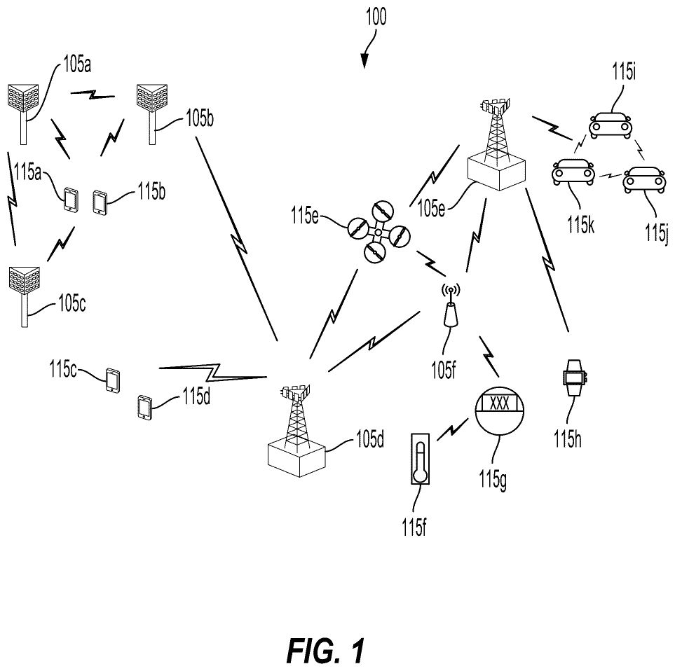

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a smart energy or security device, a solar panel or solar array, municipal lighting infrastructure, water infrastructure, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports communications with ultra-reliable and redundant links for various types of devices, such as UE 115e. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

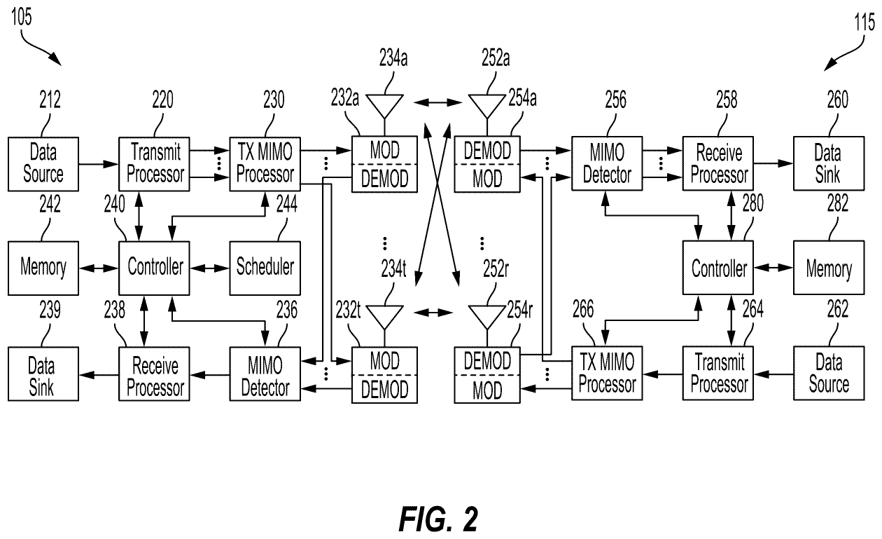

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

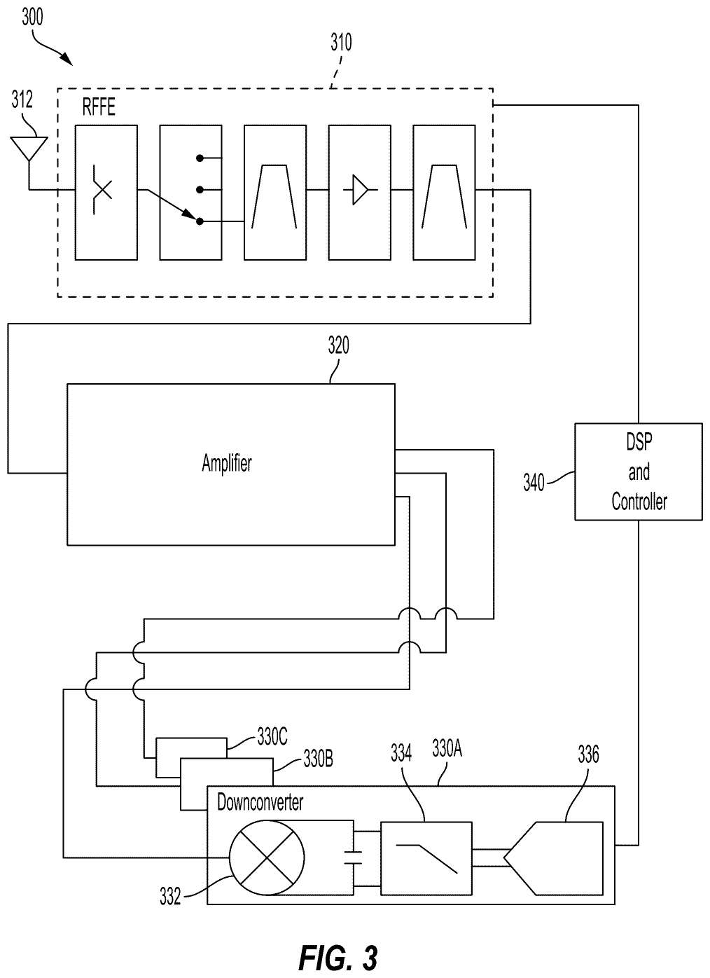

FIG. 3 is a block diagram illustrating a receiver circuit 300 according to one or more aspects. In some embodiments, the receiver circuit 300 may be part of a converged sub-6 Ghz and mmWave radio frequency (RF) transceiver, a sub-6 GHz radio frequency (RF) transceiver, or a mmWave radio frequency (RF) transceiver. In some embodiments, portions or all of the RF transceiver of FIG. 3 may be located in a single integrated circuit (IC) sharing a common substrate. The receiver circuit 300 may include an antenna 312 to receive radio frequency (RF) signals, such as a phase antenna array. The antenna 312 is coupled to a RF front-end (RFFE) 310, which may include duplexers, SAW filters, switches, LNAs, and/or other transmit or receive circuits for conditioning signals received from the antenna 312. In some embodiments, the RFFE 310 may include separate circuits for conditioning or otherwise processing sub-6 GHz signals, mmWave signals, satellite signals, and/or other signals. For example, the RFFE 310 may include a first plurality of circuits for conditioning a sub-6 GHz signal for further processing by other circuitry and a second plurality of circuits for conditioning a mmWave RF signal for further processing by other circuitry. The output of the RFFE 310 in this example may be a input RF signal to other circuitry comprising the conditioned sub-6 GHz signal and a conditioned mmWave IF signal. The RFFE 310 is coupled to an amplifier 320, such as a low noise amplifier (LNA). The amplifier 320 is coupled to one or more downconverters 330A, 330B, and 330C. Each of the downconverters 330A, 330B, and 330C may include mixers 332, baseband filters (BBFs) 334, and/or analog-to-digital converters (ADCs) 336. The downconverters 330A, 330B, 330C may include one or more harmonic rejection mixers (HRMs). In some embodiments, the amplifier 320 is shared on an IC with one or more of the RFFE 310 and/or the downconverters 330A, 330B, and 330C.

Interference between wireless signals received at antenna 312 and processed through RFFE 310, amplifier 320, and downconverters 330A-C complicates operation of the receiver circuit 300, particularly when processing a large range of potential frequencies. For example, co-location of processing paths for sub-6 Ghz and mmWave signals in an integrated circuit can create interference between the sub-6 GHz signal harmonics and the mmWave signals. Interference between sub-6 GHz signals and mmWave signals may occur because mmWave IF signals corresponding to mmWave RF signals received at an antenna from over-the-air may be located near to sub-6 GHz signals in frequency (e.g., within 1-6 GHz) and/or located at harmonics of the sub-6 GHz (e.g., at integer multiples of the sub-6 GHz signals).

Interference between wireless signals may be further complicated by carrier aggregation (CA) operation. Carrier aggregation (CA) involves the combination of one or more carrier RF signals to carry a single data stream. Carrier aggregation (CA) improves the flexibility of the wireless devices and improves network utilization by allowing devices to be assigned different numbers of carriers for different periods of time based, at least in part, on historical, instantaneous, and/or predicted bandwidth use by the wireless device. Thus, when a mobile device needs additional bandwidth, additional carriers may be assigned to that wireless device, and then de-assigned and re-assigned to other mobile devices when bandwidth demands change. As carriers are assigned and de-assigned from a mobile device, the interaction of wireless signals may change. For example, different carriers in CA may be in different bands, and certain bands may have harmonics that overlap and/or otherwise interfere with certain other bands.

A digital signal processor (DSP) and controller 340 may detect conditions in the RF signal received from the antenna 312 or receive information regarding the carrier configuration from higher levels, such as a MAC layer or network layer. The DSP and controller 340 may configure components of the receiver circuit 300 to activate, deactivate, or control portions of the receiver circuit 300 to process an input RF signal. In some embodiments, the DSP and controller 340 may configure components to reduce interference between bands within the receiver circuit 300.

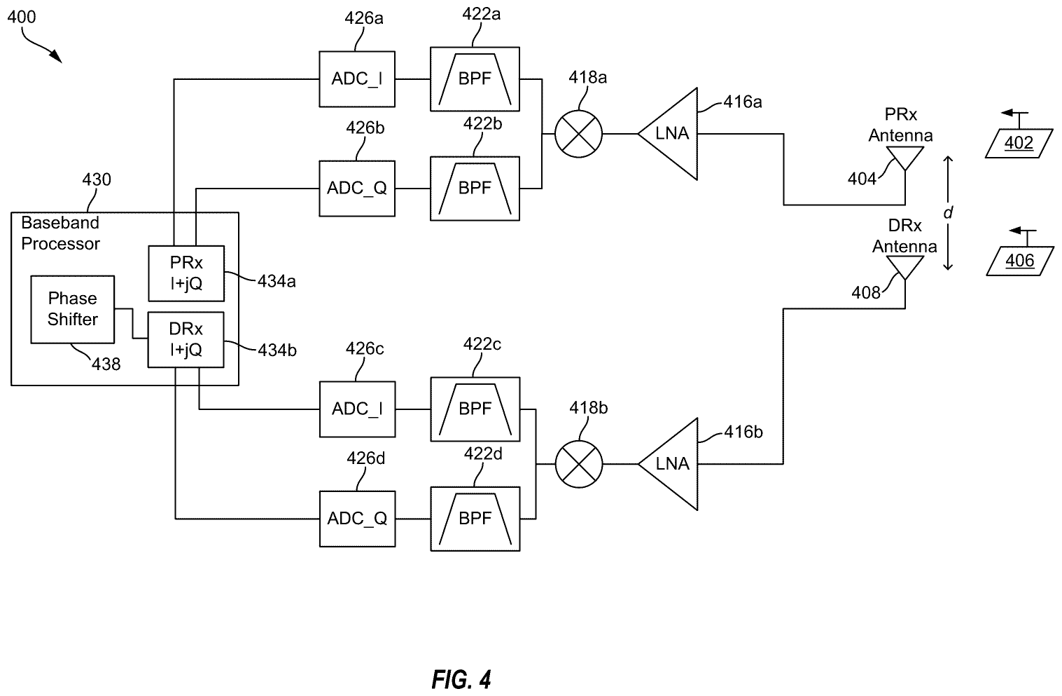

FIG. 4 is a block diagram illustrating an example of a system 400 according to one or more aspects. In some implementations, the system 400 may be included in one or more devices described with reference to FIGS. 1-3, such as the UE 115. Further, one or more components of the system 400 may be included in the receiver circuit 300 of FIG. 3.

The system 400 may include multiple antennas, such as a first antenna (e.g., a primary receive (PRx) antenna 404) and a second antenna (e.g., a diversity receive (DRx) antenna 408). The PRx antenna 404 and the DRx antenna 408 may be separated by a physical distance, which may be indicated herein as d. The physical distance may be indicated in an edge-to-edge manner (e.g., from an edge of the PRx antenna 404 to an edge of the DRx antenna 408), in a weighted manner (e.g., from a center of mass of the PRx antenna 404 to a center of mass of the DRx antenna 408), or in another manner. In some examples, the PRx antenna 404 and the DRx antenna 408 may correspond to antennas described with reference to FIGS. 2 and 3, such as any of the antennas 252a-r, the antenna 312, or a combination thereof.

In the example of FIG. 4, the PRx antenna 404 may be coupled to a PRx path that may include one or more low noise amplifiers (such as LNA 416a), a mixer 418a, bandpass filters (BPFs) 422a-b, and analog-to-digital converters (ADCs) 426a-b. In some examples, the BPF 422a and the ADC 426a may process in-phase (I) signal components of a PRx signal received via the PRx antenna 404, and the BPF 422b and the ADC 426b may process quadrature (Q) signal components of the PRx signal. In some examples, the PRx path may also be referred to as a primary receive chain or as a primary receive circuit.

The example of FIG. 4 also illustrates that the DRx antenna 408 may be coupled to a DRx path that may include one or more low noise amplifiers (such as LNA 416b), a mixer 418b, BPFs 422c-d, and ADCs 426c-d. In some examples, the BPF 422c and the ADC 426c may process I signal components of a DRx signal received via the DRx antenna 408, and the BPF 422d and the ADC 426d may process Q signal components of the DRx signal. In some examples, the DRx path may also be referred to as a diversity receive chain or as a diversity receive circuit.

The system 400 may further include one or more processors or controllers, such as a baseband processor 430. The baseband processor 430 may be coupled to the PRx path and to the DRx path. To illustrate, the baseband processor 430 may include a PRx I-and-jQ summation circuit 434a coupled to the ADCs 426a-b (where j indicates the square root of negative one). The baseband processor 430 may further include a DRx I-and-jQ summation circuit 434b coupled to the ADCs 426c-d. In some implementations, the baseband processor 430 may also include a phase shifter 438. The phase shifter 438 may include one or more hardware components of the baseband processor 430, instructions executable by the baseband processor 430 (e.g., instructions stored at a memory included in or accessible to the baseband processor 430), or a combination thereof.

During operation, the system 400 may receive one or more wireless signals, such as a wireless signal 402. In some circumstances, the wireless signal 402 may be subject to noise or interference. For example, in some circumstances, the system 400 may receive or may be subject to an interference signal 406 (also referred to herein as a jammer) that may introduce errors in the wireless signal 402, potentially causing data loss for the system 400 or requiring retransmission of the wireless signal 402.

In some aspects of the disclosure, the system 400 may receive the interference signal 406 using the DRx antenna and may phase-rotate the interference signal 406 to generate a phase-rotated version of the interference signal 406. In some examples, the system 400 may modify the wireless signal 402 based on the phase-rotated version of the interference signal 406, such as by combining the phase-rotated version of the interference signal 406 with the wireless signal 402 to reduce, mitigate, or cancel presence of the interference signal 406 from the wireless signal 402. In some aspects, modifying the wireless signal 402 based on the phase-rotated version of the interference signal 406 may be referred to herein or may include applying a spatial null to the wireless signal 402.

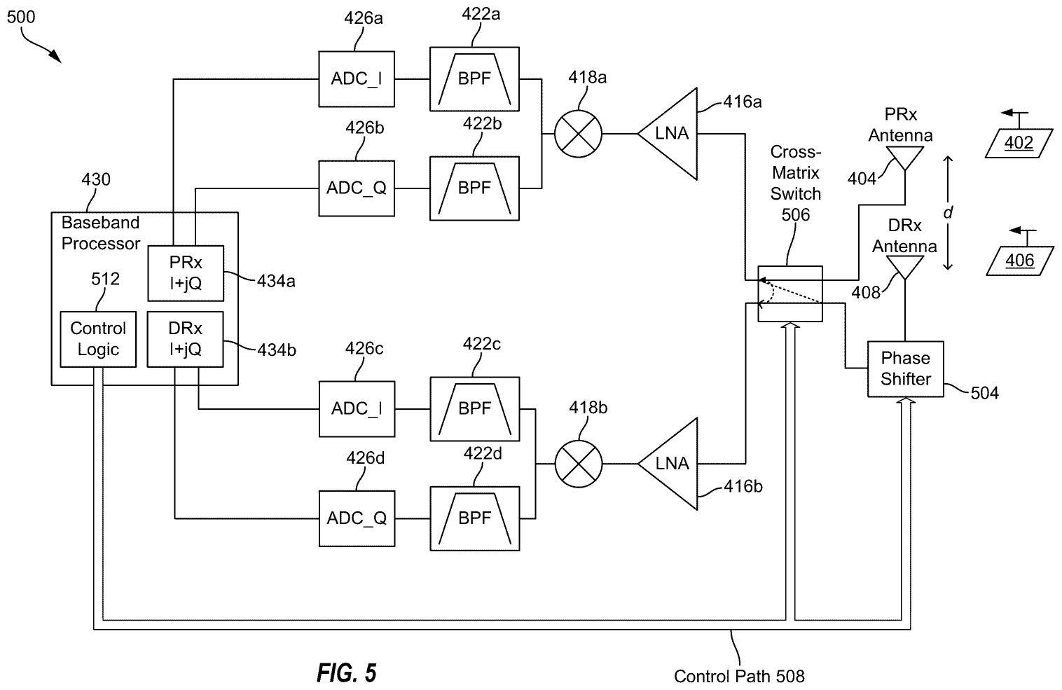

In some examples, the phase shifter 438 may perform such operations. For example, the phase shifter 438 may receive the wireless signal 402 from the PRx I-and-jQ summation circuit 434a may receive the interference signal 406 from the DRx I-and-jQ summation circuit 434b. The phase shifter 438 may phase-rotate the interference signal 406 to generate the phase-rotated version of the interference signal 406 and may modify the wireless signal 402 based on the phase-rotated version of the interference signal 406, such as by combining the phase-rotated version of the interference signal 406 with the wireless signal 402. In some aspects of the disclosure, the phase shifter 438 may include instructions executed by the baseband processor 430 to perform such operations. Alternatively, or in addition, such operations may be performed using hardware, such as in accordance with the example of FIG. 5.

In some aspects, the interference signal 406 may be associated with an angle of arrival (AoA). In some aspects, an amount of phase-rotation applied to the interference signal 406 may based on the AoA, as described further below.

FIG. 5 is a block diagram illustrating an example of a system 500 according to one or more aspects. In some implementations, the system 500 may be included in one or more devices described with reference to FIGS. 1-3, such as the UE 115. Further, one or more components of the system 500 may be included in the receiver circuit 300 of FIG. 3.

In the example of FIG. 5, the system 500 may include a phase shifter that is external to the baseband processor 430. For example, the system 500 may include a phase shifter 504 coupled to the DRx antenna 408. The phase shifter 504 may be coupled to the baseband processor 430 via one or more control paths, such as a control path 508. In some examples, the control path 508 may include one or more wires, one or more buses, one or more interconnects, one or more other structures, or a combination thereof. In some examples, the baseband processor 430 may include or may execute control logic 512 that may be associated with the control path 508.

The system 500 may further include a cross-matrix switch 506 coupled to the PRx antenna 404 and to the DRx antenna 408. In some examples, the cross-matrix switch 506 may also be referred to as a crossbar switch, a cross-point switch, or a matrix switch. The cross-matrix switch 506 may be further coupled to the PRx path (e.g., via the LNA 416a) and to the DRx path (e.g., via the LNA 416b). The cross-matrix switch 506 may be coupled to the baseband processor 430 via one or more control paths, such as the control path 508 or another control path.

During operation, the baseband processor 430 may use apply a control signal to the phase shifter 504 to determine an amount of phase rotation to apply to the interference signal 406 received by the DRx antenna 408. For example, the baseband processor 430 may execute the control logic 512 to apply the control signal to the phase shifter 504 to determine the amount of phase rotation.

Further, the baseband processor 430 may apply a control signal to the cross-matrix switch 506 to select among multiple modes that may be associated with the cross-matrix switch 506. The multiple modes may include a first mode and a second mode. In some examples, the first mode may include or may correspond to a diversity receive mode, and the second may include or may correspond to a null-steering receive mode.

To further illustrate, during operation of the cross-matrix switch 506 according to the first mode, the cross-matrix switch 506 may couple the PRx antenna 404 to the PRx path (e.g., via the LNA 416a) and may couple the DRx antenna to the DRx path (e.g., via the LNA 416b). The first mode may facilitate determination of an angle of arrival (AoA) by baseband processor 430 (or another component) based on the interference signal 406. For example, by separately receiving and processing the wireless signal 402 and the interference signal 406 using the PRx path and the DRx path, the baseband processor 430 may identify the AoA of the interference signal 406 (e.g., relative to an AoA of the wireless signal 402). Further, during the first mode, the baseband processor 430 may use the PRx path and the DRx path to receive the wireless signal 402 and the interference signal 406, respectively, and may determine a phase difference between the wireless signal 402 and the interference signal 406. In some examples, the AoA may indicated as θ, and the phase difference may be indicated as β.

During operation of the cross-matrix switch 506 according to the second mode, the cross-matrix switch 506 may couple the PRx antenna 404 to the PRx path (e.g., via the LNA 416a) and may couple the DRx antenna 408 to the PRx path (e.g., via the LNA 416a). In such examples, the cross-matrix switch 506 may couple both the PRx antenna 404 and the DRx antenna 408 to the PRx path (e.g., via the LNA 416a) while one or more components of the DRx path may operate according to a sleep, standby, or low-power mode of operation. During operation of the cross-matrix switch 506 according to the second mode, the interference signal 406 may be phase-modified based on the AoA identified during the first mode of operation.

To further illustrate, different amounts of phase shift may be applied to the interference signal 406 based on whether the cross-matrix switch 506 operates according to the first mode or the second mode. For example, a phase shifter described herein (such as the phase shifter 438 or the phase shifter 504) may apply a first amount of phase shift to the interference signal 406 during operation of the cross-matrix switch 506 according to the first mode and may apply a second amount of phase shift to the interference signal 406 during operation of the cross-matrix switch 506 according to the second mode. In some examples, the first amount may correspond to a zero or near-zero phase shift, and the second amount may correspond to a non-zero phase shift.

In some aspects of the disclosure, one or both of the systems 400, 500 include a circuit (e.g., a summation circuit) configured to generate a received signal based on the wireless signal 402 and the phase-modified version of the interference signal 406. The circuit may generate the received signal by combining (e.g., summing) the wireless signal 402 and the phase-modified version of the interference signal 406. The received wireless signal may correspond to a received version of the wireless signal 402.

To illustrate, in the example of FIG. 4, the baseband processor 430 may include or may correspond to a circuit that combines the phase-modified version of the interference signal 406 with the wireless signal 402 to generate the received wireless signal. Such a circuit may be included in the phase shifter 438 or may be coupled to the phase shifter 438 (e.g., to an output of the phase shifter 438).

As another example, in the example of FIG. 5, the cross-matrix switch 506 may include or may correspond to a circuit that combines the phase-modified version of the interference signal 406 with the wireless signal 402 to generate the received wireless signal. In such examples, the cross-matrix switch 506 may generate the received signal by combining (e.g., summing) the wireless signal 402 and the phase-modified version of the interference signal 406. The cross-matrix switch 506 may provide the received signal to the LNA 416a.

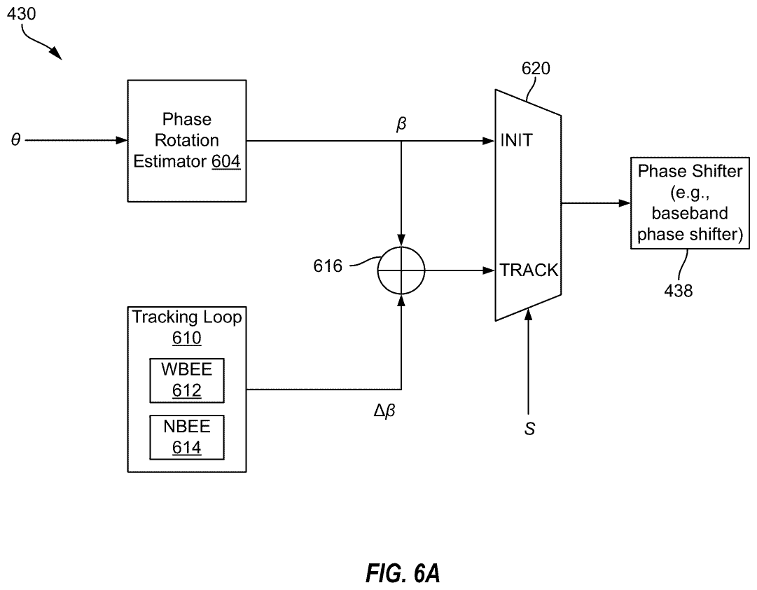

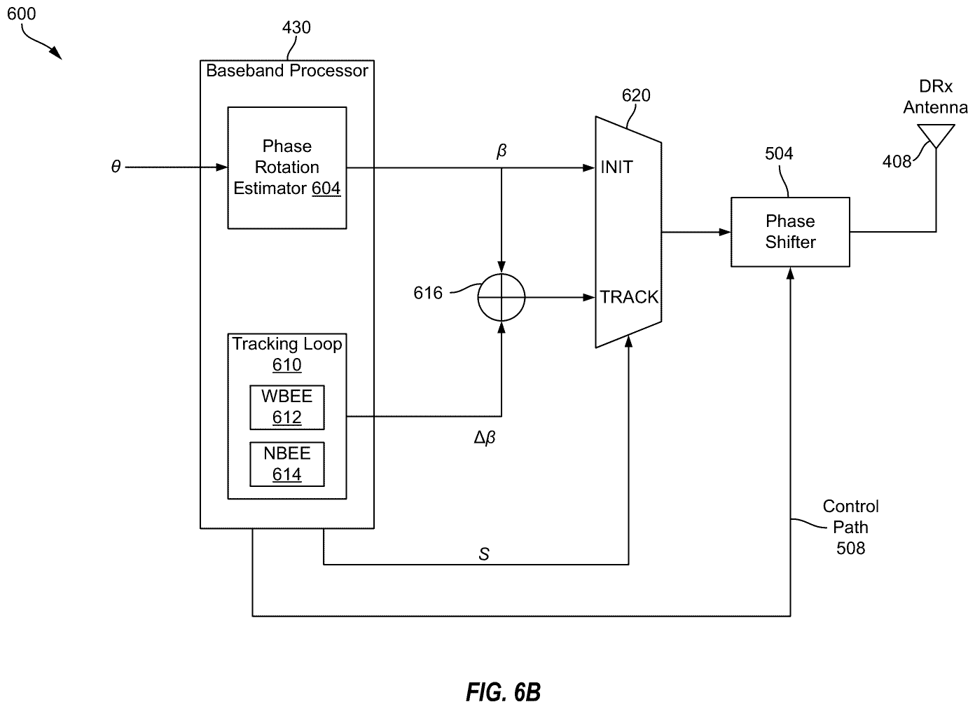

In some aspects of the disclosure, certain operations described herein may be performed selectively based on whether a wideband energy estimate (WBEE) associated with the wireless signal 402 exceeding a narrowband energy estimate (NBEE) associated with the wireless signal. For example, if the WBEE fails to exceed the NBEE, a phase shifter described herein (such as the phase shifter 438 or the phase shifter 504) may avoid phase-modifying the interference signal 406 (e.g., while the cross-matrix switch 506 operates according to the first mode). In some other examples, if the WBEE exceeds the NBEE, the phase shifter may phase-modify the interference signal 406 (e.g., while the cross-matrix switch 506 operates according to the second mode). Some such examples are described further with reference to FIGS. 6 and 7.

FIG. 6A is a block diagram illustrating examples of features that may be associated with a baseband processor, such as the baseband processor 430, according to one or more aspects. In some implementations, the baseband processor 430 of FIG. 6A may perform baseband phase tracking and null steering. For example, in the example of FIG. 6A, the phase adjustment of the interference signal 406 may be performed in a digital baseband domain.

The baseband processor 430 may be coupled to or may include one or more of a phase rotation estimator 604, a tracking loop 610, and a summation node 616. The phase rotation estimator 604 and the tracking loop 610 may be coupled to the summation node 616. The baseband processor 430 may further include or may be coupled to a selection circuit 620, such as a multiplexer (MUX). The selection circuit 620 may include a first input coupled to the phase rotation estimator 604 and may further include a second input coupled to the summation node 616. The selection circuit 620 may also include a control input coupled to the baseband processor 430.

The baseband processor 430 may further include a phase shifter coupled to the selection circuit 620. In some examples, the phase shifter may include or correspond to the phase shifter 438 of FIG. 4. In the example illustrated in FIG. 6A, the phase shifter 438 may be included in the baseband processor 430 and may be referred to as a baseband phase shifter.

During operation, the phase rotation estimator 604 may receive an indication of an AoA associated with the interference signal 406. In some examples, the AoA may indicated as θ. In some examples, the baseband processor 430 may generate the indication of the AoA, such as in accordance with Equations 1-9, below. The phase rotation estimator 604 may estimate, based on the AoA, an amount of phase difference between the wireless signal 402 and the interference signal 406 (e.g., in accordance with Equations 1-9, below). The phase difference may be indicated as β. The phase rotation estimator 604 may output an indication of the phase difference.

The tracking loop 610 may determine energy estimates associated with one or more received signals described herein. For example, the tracking loop 610 may determine a WBEE 612 associated with the wireless signal 402 and may determine a NBEE 614 associated with the wireless signal 402. To further illustrate, in some examples, to determine the WBEE 612, the tracking loop 610 may measure a first amount of energy associated with a first frequency band associated with the wireless signal 402. To determine the NBEE 614. the tracking loop 610 may measure a second amount of energy associated with a second frequency band associated with the wireless signal 402. The first frequency band may have a greater bandwidth than the second frequency band. The tracking loop 610 may monitor changes in the phase difference between the wireless signal 402 and the interference signal 406 and may output an indication of a change in the phase difference (Δβ). In some examples, various data or information may be provided to the tracking loop 610, such as one or more of a primary synchronization signal (PSS) power estimate, a secondary synchronization signal (SSS) power estimate, a signal-to-noise ratio (SNR) associated with one or more signals described herein, sensor data (e.g., gyroscope data), filtering data (e.g., Kalman filtering data), or other information.

The baseband processor 430 may provide a mode selection signal S to the selection circuit 620 to operate the selection circuit 620. To illustrate, during a TRACK mode, the mode selection signal S may have a first value that causes the selection circuit 620 to output a sum β+Δβ received from the summation node 616. By summing β+Δβ, an amount of phase rotation applied to the interference signal 406 may be modified (e.g., in response to a change in position of a device that includes the baseband processor 430, in response to a change in position of a source of the interference signal 406, or both). During an INIT mode, the mode selection signal S may have a second value that causes the selection circuit 620 to output the phase difference received from the phase rotation estimator 604.

FIG. 6B is a block diagram illustrating another example of a system 600 according to one or more aspects. In some implementations, the system 600 of FIG. 6B may perform phase tracking and analog null steering. For example, in the example of FIG. 6B, the phase adjustment of the interference signal 406 may be performed in an analog domain.

In the example of FIG. 6B, the output of the selection circuit 620 may be coupled to an input of the phase shifter 504. The phase shifter may be coupled to the output of the selection circuit 620 and to the DRx antenna 408. The phase shifter 504 may be coupled to the baseband processor 430, such as via the control path 508.

To further illustrate some aspects of the disclosure, in some examples, one or more operations described herein may be performed in accordance with Equations 1-9. Equations 1-9 may be described with reference to a coordinate system that includes an origin, where the PRx antenna 404 may be positioned at a distance of d/2 above the origin (e.g., on an ordinate of the coordinate system), and where the DRx antenna 408 may be positioned at a distance of d/2 below the origin (e.g., on the ordinate). A point P(r,θ) may be positioned at a distance r and angle θ from the origin. In some examples, the point P may represent a source of the interference signal 406. The PRx antenna 404 may be a distance r1 from the point P, and the DRx antenna 408 may be a distance r2 from the point P. The distances r1 and r2 may be represented using Equations 1 and 2, respectively:

$$r 1 = r - \frac{d}{2} cos θ ; \qquad ( Equation 1 )$$

$$r 2 = r + \frac{d}{2} cos θ . \qquad ( Equation 2 )$$

The PRx antenna 404 and the DRx antenna 408 may each be associated with a radio frequency (RF) current I and may have a length dl. The PRx antenna 404 and the DRx antenna 408 may be modeled as or represented by infinitesimal dipoles of length dl. Impedance of free space may be represented as η, and a propagation constant of free space may be represented as k. The PRx antenna 404 and the DRx antenna 408 may create electric fields E1 and E2, respectively, as indicated in Equations 3 and 4, respectively:

$$E 1 = \frac{η jkIdl}{4 π r 1} cos θ {e}^{- j k r 1} ; \qquad ( Equation 3 )$$

$$E 2 = \frac{η jkIdl}{4 π r 2} cos θ {e}^{- j k r 2} . \qquad ( Equation 4 )$$

A combined field E at point P due to the PRx antenna 404 and the DRx antenna 408 may be represented according to Equation 5:

$$E = E 1 + E 2 = \{ \frac{η jkIdl}{4 π r 1} cos θ {e}^{- j k r 1} + \frac{η jkIdl}{4 π r 2} cos θ {e}^{- j k r 2} \} . \qquad ( Equation 5 )$$

A phase difference in the excitation between the PRx antenna 404 and the DRx antenna 408 may be represented as β in Equation 6:

$$E = \frac{η jkIdl}{4 π r} cos θ \{ {e}^{- jk \{ r - \frac{dCos θ}{2} \}} {e}^{- j β / 2} + {e}^{- jk \{ r + \frac{dCos θ}{2} \}} {e}^{+ j β / 2} \} = \frac{η jkIdl}{4 π r} cos θ {e}^{- j k r} \{ {e}^{\frac{kd Cos θ + β}{2}} + {e}^{- \frac{kdCos θ + β}{2}} \} . \qquad ( Equation 6 )$$

Equation 6 may also be expressed as Equation 7:

$$E = [ \frac{η jkIdl}{4 π r} {e}^{- j r} cos θ ] [ 2 cos \{ \frac{1}{2} ( k d . cos θ + β ) \} ] . \qquad ( Equation 7 )$$

In Equation 7, the left bracketed expression may be referred to as an element factor, and the right bracketed expression may be referred as an array factor. In the element factor, cos θ may be associated with a spatial null when 0 is an odd multiple of 90 degrees (e.g., θ=−90 degrees, −180 degrees, −270 degrees, etc.). In some illustrative implementations, d=λ/8, where, may indicate a wavelength associated with received signals. In some examples, if d is approximately 5 centimeters (cm), then kd=π/4. A spatial null may be introduced in accordance with Equation 8:

$$cos \{ \frac{1}{2} ( k d . cos θ + β ) \} = cos \{ \frac{1}{2} ( \frac{π}{4} . cos θ + β ) \} = 0. \qquad ( Equation 8 )$$

If, for example, a spatial null is to be introduced at 0=45 degrees (or θ=π/4 radians), then (π/8·cos(π/4)+β/2)=(π/2) (where “.” represents a multiplication operator), which can be accomplished by setting β=2*{(π/2)−π/8·cos(π/4)} by rotating the phase of IQ data in the DRx signal relative to the PRx signal, which may equate to approximately 148 degrees. As another example, if θ=30 degrees (or θ=π/6 radians), then β=π−1.0 π cos(π/6)=24 degrees (or 0.42π radians).

In some examples, θ may be determined or estimated using one or more techniques. In some implementations, β may be initialized to β=0, and a demodulated baseband phase difference between the wireless signal 402 and the interference signal 406 may be indicated as ϕ. After determining or estimating ϕ, Equation 9 may be rearranged and solved for β:

$$ϕ = kd cos θ = πcosθ \text{=>} θ = arccos ( \frac{ϕ}{π} ) . \qquad ( Equation 9 )$$

FIG. 7 is a flow chart illustrating an example of a method 700 according to one or more aspects. In some examples, the method 700 may be performed by one or more devices described herein, such as by one or more of the UE 115, the receiver circuit 300, the system 400, or the system 500.

The method 700 may include receiving a PRx signal and a DRx signal, at 702. In some examples, the PRx signal may correspond to the wireless signal 402, and the DRx signal may correspond to the interference signal 406.

The method 700 may further include determining whether a WBEE exceeds a NBEE, at 704. For example, the WBEE may correspond to the WBEE 612, and the NBEE may correspond to the NBEE 614.

Based on the WBEE exceeding the NBEE, the method 700 may further include estimating a gain difference between the PRx signal and the DRx signal and estimating a phase difference between the PRx signal and the DRx signal, at 706. The method 700 may further include estimating a directionality associated with the DRx signal and applying a spatial null, at 708. The directionality may include or may correspond to θ. Applying the spatial null may include or correspond to combining a phase-rotated version of the interference signal 406 with the wireless signal 402.

The method 700 may further include determining whether the WBEE exceeds the NBEE, at 712. In some examples, if the WBEE fails to exceed the NBEE, the method 700 may further include performing signal-to-noise (SNR) recovery based on the spatial null, at 718. In some other examples, if the WBEE exceeds the NBEE, the method 700 may further include increasing receive gain sensitivity to reduce or avoid saturation, at 710.

Referring again to 704, if the WBEE fails to exceed the NBEE, the method 700 may further include determining whether an SNR difference between the PRx signal and the DRx signal exceeds a threshold, at 714. In some examples, if the SNR difference exceeds the threshold, the method 700 may further include performing maximal-ratio combining (MRC) of the PRx signal and the DRx signal, at 716, and may further include performing SNR recovery based on the MRC, at 722. In some other examples, if the SNR difference fails to exceed the threshold, the method 700 may further include increasing a gain state (GS) to compensate for reduced SNR, at 720.

Although certain examples may be described herein for illustration, other examples are also within the scope of the disclosure. For example, certain examples may be described with reference to one PRx antenna and PRx path and one DRx antenna and DRx path. In some other examples, a receiver may include multiple PRx antennas and PRx paths, multiple DRx antennas and DRx paths, or a combination thereof.

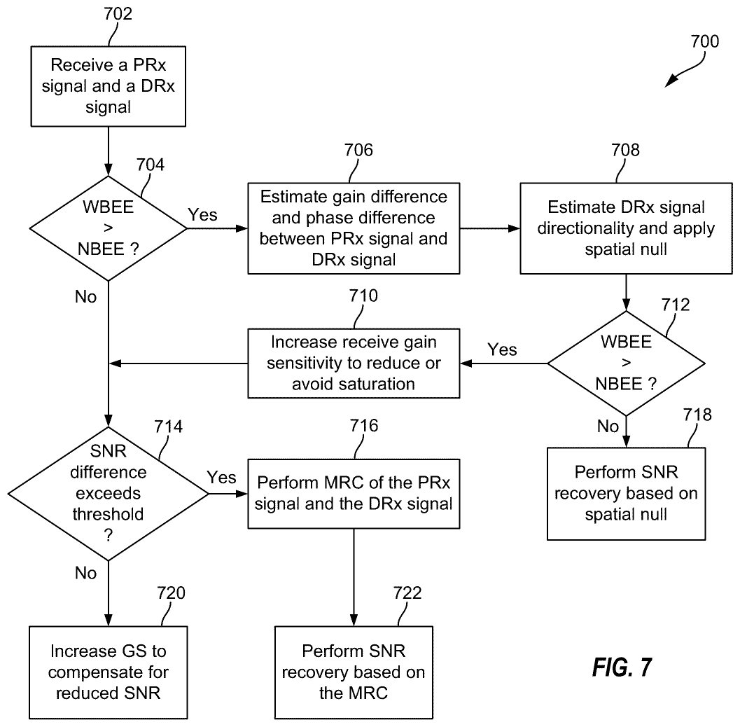

FIG. 8 is a flow chart illustrating an example of a method 800 according to one or more aspects. In some examples, the method 800 may be performed by one or more devices described herein, such as by one or more of the UE 115, the receiver circuit 300, the system 400, or the system 500.

The method 800 includes receiving a wireless signal using a PRx path that is associated with a first antenna, at 802. For example, the UE 115 may receive the wireless signal 402 using the PRx path that may include any of the LNA 416a, the mixer 418a, the BPFs 422a-b, and the ADCs 426a-b. The PRx path may be associated with the PRx antenna 404.

The method 800 further includes receiving an interference signal using a DRx path that is associated with a second antenna, at 804. For example, the UE 115 may receive the interference signal 406 using the DRx path that may include any of the LNA 416b, the mixer 418b, the BPFs 422c-d, and the ADCs 426c-d. The DRx path may be associated with the DRx antenna 408.

The method 800 further includes phase-modifying the interference signal based at least in part on a physical distance between the first antenna and the second antenna and further based on an AoA associated with the interference signal, at 806. In some examples, the UE 115 may phase-modify the interference signal 406 using the phase shifter 438 to generate a phase-modified version of the interference signal 406. In some other examples, the UE 115 may phase-modify the interference signal 406 using the phase shifter 504 to generate the phase-modified version of the interference signal 406. In some examples, the physical distance may correspond to d, and the AoA may correspond to θ.

The method 800 further includes generating a received signal based on the wireless signal and the phase-modified interference signal, at 808. For example, the UE 115 may generate the received signal by combining (e.g., summing) the wireless signal 402 and the phase-modified version of the interference signal 406.

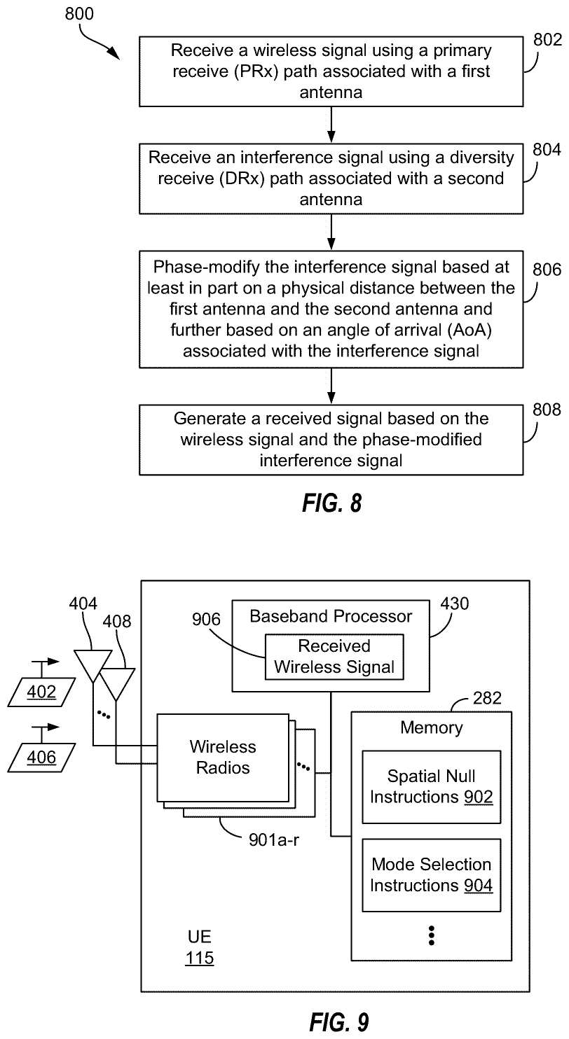

FIG. 9 is a block diagram of an example of a UE 115 according to one or more aspects. The UE 115 may include one or more features described herein. For example, the UE 115 may include the PRx antenna 404 and the DRx antenna 408 coupled to one or more wireless radios 901a-r. The one or more wireless radios 901a-r may include, for example, one or more features illustrated in the examples of FIGS. 2-6B. The UE 115 may also include a processing system that includes processor circuitry and memory circuitry that stores code. The processing circuitry may include one or more processors, such as the receive processor 238, the controller 280, the DSP and controller 340, the baseband processor 430, one or more other processors, or a combination thereof. The memory circuitry may include the memory 242, one or more other memories, or a combination thereof.

In some examples, the memory 282 may store instructions executable by the baseband processor 430 to initiate, perform, or control one or more operations described herein. For example, the memory 282 may store spatial null instructions 902 executable by the baseband processor 430 to combine (e.g., sum) the wireless signal 402 with a phase-modified version of the interference signal 406 to generate a received wireless signal 906. As another example, the memory 282 may store mode selection instructions 904 executable by the baseband processor 430 to control operation of the cross-matrix switch 506, such as by selecting a value of a control signal provided to the cross-matrix switch 506 via the control path 508. To further illustrate, a first value of the control signal may cause the cross-matrix switch 506 to operate according to the first mode, and a second value of the control signal may cause the cross-matrix switch 506 to operate according to the second mode.

One or more features described herein may improve performance of a UE or other device that includes a receiver. For example, interference reduction via phase rotation of the interference signal 406 may be facilitated using relatively low-cost instructions, hardware, or both, and may be implemented instead of costly filters or other techniques. Further, by reducing the interference signal 406 in the wireless signal 402, a higher gain may be applied to the wireless signal 402 without causing receiver saturation, which may be beneficial in some cases in which the wireless signal 402 has a relatively small amplitude (e.g., where the UE 115 is near the periphery of a cell).

To further illustrate some aspects of the disclosure, in a first aspect, an apparatus for wireless communication by a user equipment (UE) includes a primary receive (PRx) antenna associated with a first antenna and configured to receive a wireless signal. The apparatus further includes a diversity receive (DRx) path associated with a second antenna. The apparatus further includes a phase shifter configured to phase-modify an interference signal from the second antenna based at least in part on a physical distance between the first antenna and the second antenna and further based on an angle of arrival (AoA) associated with the interference signal. The apparatus further includes a circuit configured to generate a received signal based on the wireless signal and the phase-modified interference signal.

In a second aspect in combination with the first aspect, the apparatus further includes a cross-matrix switch coupled to the first antenna, to the second antenna, to the PRx path, and to the DRx path. The cross-matrix switch is associated with a first mode and a second mode.

In a third aspect in combination with one or more of the first aspect or the second aspect, the cross-matrix switch is configured to couple the first antenna to the PRx path and to couple the second antenna to the DRx path during operation according to the first mode to facilitate determination of the AoA by a baseband processor or other component based on the interference signal.

In a fourth aspect in combination with one or more of the first aspect through the third aspect, the cross-matrix switch is configured to couple the first antenna to the PRx path and couple the second antenna to the PRx path during operation according to the second mode.

In a fifth aspect in combination with one or more of the first aspect through the fourth aspect, the phase shifter is further configured to apply a first amount of phase shift to the interference signal during operation of the cross-matrix switch according to the first mode and to apply a second amount of phase shift to the interference signal during operation of the cross-matrix switch according to the second mode.

In a sixth aspect in combination with one or more of the first aspect through the fifth aspect, the first amount corresponds to a zero or near-zero phase shift, and wherein the second amount corresponds to a non-zero phase shift.

In a seventh aspect in combination with one or more of the first aspect through the sixth aspect, the phase shifter is further configured to phase-modify the interference signal further based on a wideband energy estimate (WBEE) associated with the wireless signal exceeding a narrowband energy estimate (NBEE) associated with the wireless signal.

In an eighth aspect in combination with one or more of the first aspect through the seventh aspect, the apparatus further includes a baseband processor configured to process the wireless signal.

In a ninth aspect in combination with one or more of the first aspect through the eighth aspect, the phase shifter is included in or corresponds to the baseband processor.

In a tenth aspect in combination with one or more of the first aspect through the ninth aspect, the phase shifter is coupled to the second antenna, and the apparatus further includes a control path coupled to the baseband processor and to the phase shifter.

In an eleventh aspect, a method of wireless communication by a user equipment (UE) includes receiving a wireless signal using a primary receive (PRx) path that is associated with a first antenna. The method further includes receiving an interference signal using a diversity receive (DRx) path that is associated with a second antenna. The method further includes phase-modifying the interference signal based at least in part on a physical distance between the first antenna and the second antenna and further based on an angle of arrival (AoA) associated with the interference signal. The method also includes generating a received signal based on the wireless signal and the phase-modified interference signal.

In a twelfth aspect in combination with the eleventh aspect, the method further includes operating a cross-matrix switch according to a first mode to couple the first antenna to the PRx path and to couple the second antenna to the DRx path to facilitate determination of the AoA by a baseband processor or other component based on the interference signal.

In a thirteenth aspect in combination with one or more of the eleventh aspect through the twelfth aspect, the method further includes operating the cross-matrix switch according to a second mode to couple the first antenna to the PRx path and couple the second antenna to the PRx path.

In a fourteenth aspect in combination with one or more of the eleventh aspect through the thirteenth aspect, a first amount of phase shift is applied to the interference signal during operation of the cross-matrix switch according to the first mode, and a second amount of phase shift is applied to the interference signal during operation of the cross-matrix switch according to the second mode.

In a fifteenth aspect in combination with one or more of the eleventh aspect through the fourteenth aspect, the first amount corresponds to a zero or near-zero phase shift, and the second amount corresponds to a non-zero phase shift.

In a sixteenth aspect in combination with one or more of the eleventh aspect through the fifteenth aspect, the interference signal is phase-modified further based on a wideband energy estimate (WBEE) associated with the wireless signal exceeding a narrowband energy estimate (NBEE) associated with the wireless signal.

In a seventeenth aspect in combination with one or more of the eleventh aspect through the sixteenth aspect, the method further includes processing the wireless signal by a baseband processor.

In an eighteenth aspect in combination with one or more of the eleventh aspect through the seventeenth aspect, the interference signal is phase-modified by a phase shifter of the baseband processor.

In a nineteenth aspect in combination with one or more of the eleventh aspect through the eighteenth aspect, the interference signal is phase-modified by a phase shifter that is external to the baseband processor.

In a twentieth aspect, a non-transitory computer-readable medium stores instructions executable by one or more processors to initiate, control, or perform operations. The operations include receiving a wireless signal using a primary receive (PRx) path that is associated with a first antenna. The operations further include receiving an interference signal using a diversity receive (DRx) path associated with a second antenna. The operations further include phase-modifying the interference signal based at least in part on a physical distance between the first antenna and the second antenna and further based on an angle of arrival (AoA) associated with the interference signal. The operations further include generating a received signal based on the wireless signal and the phase-modified interference signal.

In a twenty-first aspect in combination with the twentieth aspect, the operations further include operating a cross-matrix switch according to a first mode to couple the first antenna to the PRx path and to couple the second antenna to the DRx path to facilitate determination of the AoA by a baseband processor or other component based on the interference signal.

In a twenty-second aspect in combination with one or more of the twentieth aspect through the twenty-first aspect, the operations further include operating the cross-matrix switch according to a second mode to couple the first antenna to the PRx path and couple the second antenna to the PRx path.

In a twenty-third aspect in combination with one or more of the twentieth aspect through the twenty-second aspect, a first amount of phase shift is applied to the interference signal during operation of the cross-matrix switch according to the first mode, and a second amount of phase shift is applied to the interference signal during operation of the cross-matrix switch according to the second mode.

In a twenty-fourth aspect in combination with one or more of the twentieth aspect through the twenty-third aspect, the first amount corresponds to a zero or near-zero phase shift, and the second amount corresponds to a non-zero phase shift.

In a twenty-fifth aspect in combination with one or more of the twentieth aspect through the twenty-fourth aspect, the interference signal is phase-modified further based on a wideband energy estimate (WBEE) associated with the wireless signal exceeding a narrowband energy estimate (NBEE) associated with the wireless signal.

In a twenty-sixth aspect, an apparatus includes a processing system that includes processor circuitry and memory circuitry that stores code. The processing system is configured to receive a wireless signal using a primary receive (PRx) path associated with a first antenna and to receive an interference signal using a diversity receive (DRx) path associated with a second antenna antenna. The processing system is further configured to phase-modify the interference signal based at least in part on a physical distance between the first antenna and the second antenna and further based on an angle of arrival (AoA) associated with the interference signal. The processing system is further configured to generate a received signal based on the wireless signal and the phase-modified interference signal.

In a twenty-seventh aspect in combination with the twenty-sixth aspect, the processing system is further configured to operate a cross-matrix switch according to a first mode to couple the first antenna to the PRx path and to couple the second antenna to the DRx path to facilitate determination of the AoA by a baseband processor or other component based on the interference signal.

In a twenty-eighth aspect in combination with one or more of the twenty-sixth aspect through the twenty-seventh aspect, the processing system is further configured to operate the cross-matrix switch according to a second mode to couple the first antenna to the PRx path and couple the second antenna to the PRx path.

In a twenty-ninth aspect in combination with one or more of the twenty-sixth aspect through the twenty-eighth aspect, the processing system is further configured to apply a first amount of phase shift to the interference signal during operation of the cross-matrix switch according to the first mode and to apply a second amount of phase shift to the interference signal during operation of the cross-matrix switch according to the second mode.

In a thirtieth aspect in combination with one or more of the twenty-sixth aspect through the twenty-ninth aspect, the first amount corresponds to a zero or near-zero phase shift, and wherein the second amount corresponds to a non-zero phase shift.

In a thirty-first aspect, an apparatus for wireless communication by a user equipment (UE) includes means for receiving a wireless signal associated with a first antenna and further includes means for receiving an interference signal associated with a second antenna. The apparatus further includes means for phase-modifying the interference signal based at least in part on a physical distance between the first antenna and the second antenna and further based on an angle of arrival (AoA) associated with the interference signal. The apparatus further includes means for generating a received signal based on the wireless signal and the phase-modified interference signal. In some examples, the means for receiving the wireless signal may include or correspond to a PRx path described herein and may include one or more of the LNA 416a, the mixer 418a, the BPFs 422a-b, and the ADCs 426a-b. In some examples, the means for receiving the interference signal may include or correspond to a DRx path described herein and may include one or more of the LNA 416b, the mixer 418b, the BPFs 422c-d, and the ADCs 426c-d. In some examples, the means for phase-modifying the interference signal may include or correspond to the phase shifter 438 or the phase shifter 504. In some examples, the means for generating the received signal may include or correspond to the baseband processor 430 or the phase shifter 504.

In a thirty-second aspect in combination with the thirty-first aspect, the apparatus further includes means for baseband processing the wireless signal. In some examples, the means for baseband processing the wireless signal may include or correspond to the baseband processor 430.

In a thirty-third aspect in combination with the thirty-second aspect, the means for phase-modifying the interference signal is included in the means for baseband processing.

In a thirty-fourth aspect in combination with the thirty-second aspect, the means for phase-modifying the interference signal is external to the means for baseband processing.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and features described herein may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to one of the figures may be combined with one or more blocks (or operations) described with reference to another of the figures. For example, one or more blocks (or operations) of FIG. 6A may be combined with one or more blocks (or operations) of FIG. 4. As another example, one or more blocks (or operations) of FIG. 6B may be combined with one or more blocks (or operations) of FIG. 5. Those of skill in the art will recognize that other such examples are within the scope of the disclosure.

The various illustrative logics, logical blocks, modules, circuits and operations described herein may be implemented as electronic hardware, computer software, or combinations of both. Whether such functionality is implemented in hardware or software may depend upon the particular application and design of the overall system.

A hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, one or more functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes computer storage media. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for wireless communication by a user equipment (UE), the apparatus comprising:
a primary receive (PRx) path associated with a first antenna and configured to receive a wireless signal;
a diversity receive (DRx) path associated with a second antenna;
a phase shifter configured to phase-modify an interference signal from the second antenna based at least in part on a physical distance between the first antenna and the second antenna and further based on an angle of arrival (AoA) associated with the interference signal; and
a circuit configured to generate a received signal based on the wireless signal and the phase-modified interference signal.

2. The apparatus of claim 1, further comprising a cross-matrix switch coupled to the first antenna, to the second antenna, to the PRx path, and to the DRx path, wherein the cross-matrix switch is associated with a first mode and a second mode.

3. The apparatus of claim 2, wherein the cross-matrix switch is configured to couple the first antenna to the PRx path and to couple the second antenna to the DRx path during operation according to the first mode to facilitate determination of the AoA by a baseband processor or other component based on the interference signal.

4. The apparatus of claim 2, wherein the cross-matrix switch is configured to couple the first antenna to the PRx path and couple the second antenna to the PRx path during operation according to the second mode.

5. The apparatus of claim 4, wherein the phase shifter is further configured to apply a first amount of phase shift to the interference signal during operation of the cross-matrix switch according to the first mode and to apply a second amount of phase shift to the interference signal during operation of the cross-matrix switch according to the second mode.

6. The apparatus of claim 5, wherein the first amount corresponds to a zero or near-zero phase shift, and wherein the second amount corresponds to a non-zero phase shift.

7. The apparatus of claim 1, wherein the phase shifter is further configured to phase-modify the interference signal further based on a wideband energy estimate (WBEE) associated with the wireless signal exceeding a narrowband energy estimate (NBEE) associated with the wireless signal.

8. The apparatus of claim 1, further comprising a baseband processor configured to process the wireless signal.

9. The apparatus of claim 8, wherein the phase shifter is included in or corresponds to the baseband processor.

10. The apparatus of claim 8, wherein the phase shifter is coupled to the second antenna, and further comprising a control path coupled to the baseband processor and to the phase shifter.

11. A method of wireless communication by a user equipment (UE), the method comprising:
receiving a wireless signal using a primary receive (PRx) path that is associated with a first antenna;
receiving an interference signal using a diversity receive (DRx) path that is associated with a second antenna;
phase-modifying the interference signal based at least in part on a physical distance between the first antenna and the second antenna and further based on an angle of arrival (AoA) associated with the interference signal; and
generating a received signal based on the wireless signal and the phase-modified interference signal.

12. The method of claim 11, further comprising operating a cross-matrix switch according to a first mode to couple the first antenna to the PRx path and to couple the second antenna to the DRx path to facilitate determination of the AoA by a baseband processor or other component based on the interference signal.

13. The method of claim 12, further comprising operating the cross-matrix switch according to a second mode to couple the first antenna to the PRx path and couple the second antenna to the PRx path.

14. The method of claim 13, wherein a first amount of phase shift is applied to the interference signal during operation of the cross-matrix switch according to the first mode, and wherein a second amount of phase shift is applied to the interference signal during operation of the cross-matrix switch according to the second mode.

15. The method of claim 14, wherein the first amount corresponds to a zero or near-zero phase shift, and wherein the second amount corresponds to a non-zero phase shift.

16. The method of claim 11, wherein the interference signal is phase-modified further based on a wideband energy estimate (WBEE) associated with the wireless signal exceeding a narrowband energy estimate (NBEE) associated with the wireless signal.

17. An apparatus for wireless communication by a user equipment (UE), the apparatus comprising:
means for receiving a wireless signal associated with a first antenna;
means for receiving an interference signal associated with a second antenna;
means for phase-modifying the interference signal based at least in part on a physical distance between the first antenna and the second antenna and further based on an angle of arrival (AoA) associated with the interference signal; and
means for generating a received signal based on the wireless signal and the phase-modified interference signal.

18. The apparatus of claim 17, further comprising means for baseband processing the wireless signal.

19. The apparatus of claim 18, wherein the means for phase-modifying the interference signal is included in the means for baseband processing.

20. The apparatus of claim 18, wherein the means for phase-modifying the interference signal is external to the means for baseband processing.
